(19) United States
(12) Patent Application Publication
(10) Pub. No.: US 2010/0111002 A1
(43) Pub. Date: May 6, 2010

(54) Method for Establishing a Packet Switched Call at a Dual Mode Access Terminal

(75) Inventors: Xiang Xu, Jiangsu (CN); Chuan Xu, Beijing (CN); Wei-Dong Zuo, Beijing (CN)

Correspondence Address: MOTOROLA INC, 600 NORTH US HIGHWAY 45, W4 - 39Q, LIBERTYVILLE, IL, 60048-5343, US

(73) Assignee: MOTOROLA, INC, SCHAUMBURG, IL (US)

(21) Appl. No.: 12/375,440

(22) PCT Filed: Jul. 9, 2007
(86) PCT No.: PCT/US07/73024

§ 371 Date: Nov. 23, 2009

(51) Int. Cl. H04W 88/16; H04L 12/66; H04W 72/04

(52) U.S. Cl. 370/329; 370/352; 370/411

(57) ABSTRACT

A method for establishing a packet switched call at an access terminal, which is processing an established circuit switched call, enables a user to be informed that the packet switched call has been requested. The method comprises adding a call type indication to a call setup message in a serving network, where the call type indication indicates that the packet switched call is requested to be setup in a packet data radio access network in the serving network (step 1105). A message indicating that the packet switched call has been requested is then transmitted from a circuit switched base station to the access terminal (step 1115). A message indicating that the packet switched call has been accepted is then transmitted from the circuit switched base station to the mobile switching center (step 1125).

### FIELD OF THE INVENTION

The present invention relates generally to dual mode access terminals that can process both packet switched and circuit switched calls. In particular, the invention relates to establishing a packet switched call at an access terminal that is processing an established circuit switched call.

### BACKGROUND OF THE INVENTION

An Internet Protocol (IP) Multimedia Subsystem (IMS) is a core network that combines IP multimedia and telephony. IMS standards have been provided by the Third Generation Partnership Project (3GPP), Third Generation Partnership Project 2 (3GPP2), and Internet Engineering Task Force (IETF) organizations and define a generic architecture for Voice over IP (VoIP) and multimedia services. In conjunction with cellular/Wi-Fi dual-mode wireless communication devices, users are able to employ IMS to obtain seamless mobility and Voice Call Continuity (VCC) between conventional circuit switched (CS) networks and packet switched (PS) networks.

Evolution of cellular communications has resulted in a proliferation of networks that use different technologies and corresponding different air interfaces. An example of a circuit radio access network (RAN) is a code division multiple access (cdma) cdma2000 1X RAN providing only circuit voice or circuit data service. Some examples of packet data network technologies employed in packet RANs include cdma2000 high rate packet data (HRPD), also known as 1XEV-DO (1X Evolution Data Only), cdma2000 1XRTT, cdma2000 1X-EV-DV (1X Evolution Data/Voice), IEEE 802.11a/b/g, and IEEE 802.16. The associated packet RANs can provide various multimedia services, such as video telephony (VT) services.

As a result, during the course of an established call in one RAN, it is often desirable to provide service notification information concerning another incoming call from another RAN. If a user accepts the new incoming service, it is then also desirable to establish a service connection in the other RAN. However, IMS standards and technologies have not provided efficient means for notifying a dual-mode device, which is currently conducting a circuit-switched service in a circuit RAN, that a packet-switched service has been requested in a packet RAN. Also, current standards and technologies have not provided efficient means for establishing a new service in a second RAN after a user decides to accept the new service. Yet such notifications and service establishment can be useful to enable device users to obtain the full benefits of IMS networks.

### SUMMARY OF THE INVENTION

According to one aspect, the present invention is a method for establishing a packet switched call at an access terminal that is processing an established circuit switched call. The method comprises adding a call type indication to a call setup message in a serving network, where the call type indication indicates that the packet switched call is requested to be setup in a packet data radio access network. In response to the call setup message, a message indicating that the packet switched call has been requested is then transmitted from a mobile switching center in the serving network to a circuit switched base station in the serving network. A message indicating that the packet switched call has been requested is then transmitted from the circuit switched base station to the access terminal. A message from the access terminal indicating that the packet switched call has been accepted is then processed at the circuit switched base station. Next, a message indicating that the packet switched call has been accepted is transmitted from the circuit switched base station to the mobile switching center. Finally, the packet switched call is connected.

Advantages of embodiments of the present invention thus include enabling an access terminal that has dual mode capabilities, such as a dual mode cellular telephone or other wireless communication device, that is operating in a circuit switched mode and processing an established circuit switched call, to receive a message indicating that a packet switched call, such as a video telephony call, to the access terminal has been requested. Using a call waiting feature of the access terminal, a user is able to either accept or reject the requested packet switched call. If the packet switched call is accepted, the circuit switched call is released and the packet switched call is established.

### BRIEF DESCRIPTION OF THE DRAWINGS

In order that the invention may be readily understood and put into practical effect, reference now will be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a block diagram illustrating a wireless communication system in accordance with some embodiments of the present invention.

FIG. 2 is a block diagram illustrating a wireless communication system in accordance with some other embodiments of the present invention.

FIG. 3 is a block diagram illustrating an architecture of an access terminal (AT), in accordance with some embodiments of the present invention.

FIG. 4 is a block diagram illustrating an architecture of a base station (BS), in accordance with some embodiments of the present invention.

FIG. 5 is a block diagram illustrating an architecture of a mobile switching center (MSC), in accordance with some embodiments of the present invention.

FIG. 6 is a block diagram illustrating an architecture of a media gateway control function (MGCF), in accordance with some embodiments of the present invention.

FIG. 7 is a block diagram illustrating an architecture of a voice call continuity application server (VCC AS), in accordance with some embodiments of the present invention.

FIGS. 8A and 8B are message sequence charts illustrating a method for establishing a video telephony (VT) call at an AT that is processing an established circuit switched (CS) call through a circuit services network, according to some embodiments of the present invention;

FIGS. 9A and 9 B are message sequence charts illustrating a method for establishing a video telephony (VT) call at an AT that is processing an established circuit switched (CS) call through a circuit services network, according to some other embodiments of the present invention;

FIGS. 10A and 10B are message sequence charts illustrating a method for establishing a video telephony (VT) call at an AT that is processing an established circuit switched (CS) call through a circuit services network, according to still other embodiments of the present invention; and

FIG. 11 is a general flow diagram illustrating a method for establishing a packet switched call at an access terminal that is processing an established circuit switched call, according to some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to establishing a packet switched call at an access terminal that is processing an established circuit switched call. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as left and right, first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

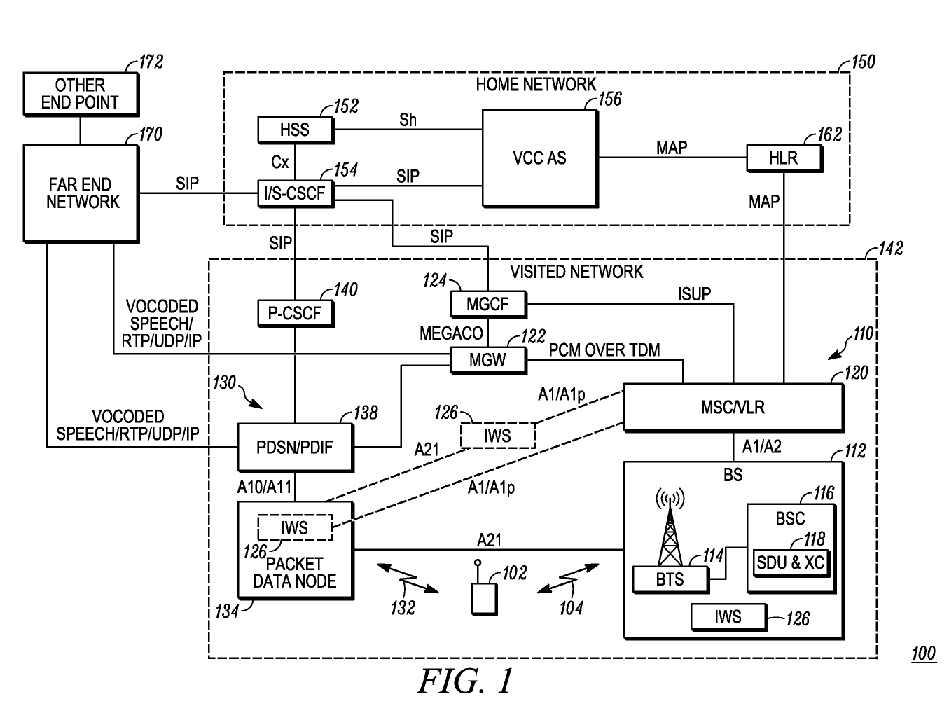

Turning now to the drawings, the present invention may be more fully described with reference to FIGS. 1-11. Referring to FIG. 1, a block diagram illustrates a wireless communication system 100, in accordance with some embodiments of the present invention. Communication system 100 includes a wireless access terminal (AT) 102, for example but not limited to a cellular telephone, a radiotelephone, or a Personal Digital Assistant (PDA), personal computer (PC), or laptop computer equipped for wireless voice communications. In various communications systems, AT 102 may also be referred to as a subscriber unit (SU), a mobile station (MS), a hybrid terminal, or a user's equipment (UE). AT 102 is capable of engaging in a packet data call with packet data network 130 and is further capable of engaging in a circuit voice or data call with circuit services network 110, and more particularly is capable of communicating with packet data node 134.

As depicted in FIG. 1, AT 102 is associated with a first, home network 150 but resides in a second, visited network 142. Visited network 142 includes both a wireless circuit services cellular communication network 110, such as a cdma2000 (Code Division Multiple Access 2000) 1X network, and a wireless packet data communication network 130 that provides VoIP services, such as a cdma2000 HRPD (High Rate Packet Data) packet data communication network 130. 1X is a spectrally efficient technology for circuit-switched voice communications, which enables applications such as multimedia messaging and GPS-based location services. Circuit services network 110 includes a Base Station (BS) 112 that comprises a Base Transceiver Station (BTS) 114 operably coupled to a Base Station Controller (BSC) 116. BS 112 is coupled to a Mobile Switching Center (MSC) 120 via both a signaling (A1) and a bearer (A2) interface. MSC 120 includes call control and mobility management functionality (not shown), such as a Visited Location Register (VLR), and switching functionality (not shown) and is coupled to a Media Gateway (MGW) 122 via a bearer interface, preferably a Pulse Code Modulation over Time Division Multiplexing (PCM over TDM) interface. Circuit services network 110 further includes a Media Gateway Control Function (MGCF) 124 that is coupled to each of MGW 122 and MSC 120 via a signaling interface, preferably to MGW 122 via a Media Gateway Control protocol (Megaco) interface and to MSC 120 via an ISDN User Part (ISUP) interface.

BSC 116 provides selection and distribution unit functionality with respect to messages received from Access Terminals (ATs) serviced by the BSC and further provides transcoding functionality in functional block 118 with respect to transcoding between the vocoder formats provided by the ATs and the vocoder formats provided by networks coupled to network 110, such as a 64 kbps PCM format (ITU-T G.711). However, in other embodiments of the present invention, the transcoding functionality may reside in MSC 120 instead of BSC 116. MGW 122 provides a gateway for circuit services network 110 to far end network 170, for example, an external data network such as an Internet Protocol (IP) network such as the Internet. When AT 102 is engaged in a voice call with an other end point (OEP) 172 via circuit services network 110 and far end network 170, MGW 122 converts Pulse Code Modulation (PCM) signals received from MSC 120 to data packets, for example, based on a Real Time Protocol/User Datagram Protocol/Internet Protocol (RTP/UDP/IP) protocol suite, for routing to external data network 170 and converts voice data received from data network 170 to a PCM over TDM (Time Division Multiplex) format for routing to MSC 120.

Packet data network 130 comprises a packet data node 134 coupled to a Packet Data Serving Node (PDSN) 138, or when packet data network 130 is a WLAN network to a Packet Data Interworking Function (PDIF), via a bearer (A10) interface and a signaling (A11) interface. PDSN 138 further has a signaling control path connection with a Proxy-Call Session Control Function (P-CSCF) 140 and is connected to far end network 170 via an interface supporting the RTP/UDP/IP protocol suite for an exchange of packet data when engaged in a packet data session with the OEP 172. Packet data node 134 provides wireless packet data communication services to ATs located in a coverage area of the packet data node. Packet data node 134 comprises a wireless Access Network (AN) (not shown), such as a BTS coupled to a BSC, an Access Point (AP), or a Node B coupled to a Radio Network Controller (RNC). Packet data node 134 may further comprise a Packet Control Function (PCF) (not shown) that may be coupled to the AN via one or more of a bearer connection and a signaling connection, such as an A8 and an A9 interface. When packet data node 134 comprises an AN and a PCF, the functionality described herein as being performed by packet data node 134 may be performed by either the AN or the PCF or may be distributed among the AN and the PCF.

Each of BS 112 and packet data node 134 provides wireless communication services to Access Terminals (ATs) located in a coverage area of the BS or packet data node via a respective 1X air interface 104 and HRPD air interface 132. Each air interface 104, 132 includes a forward link that includes a pilot channel, at least one forward link traffic channel, and forward link common and dedicated signaling channels. Each air interface 104, 132 further includes a reverse link that includes at least one reverse link traffic channel, reverse link common and dedicated signaling channels, and an access channel.

Circuit services network 110 and packet data network 130, and more particularly BS 112 and packet data node 134, communicate with each other via an Interworking Solution function (IWS) 126. IWS 126 provides an interworking function between packet data network 130 and circuit services network 110 via an A21 inter-RAN interface and supports A21 signaling with the circuit services network. An inter-RAN interface is described in detail in U.S. patent application Ser. No. 11/141,926, attorney docket number CE13247R, which patent application is commonly owned and incorporated herein by reference in its entirety. Further, an A21 inter-RAN interface and an IWS are described in the 3GPP2 A.S0008-B v0.2 and A.S0009-B v0.2 standards. IWS 126 interfaces to packet data network 130 and supports packet data, and in particular HRPD, signaling. IWS 126 provides an interworking function allowing packet data network 130 to convey HRPD air interface signaling to an AT in the circuit services network, thereby permitting an HRPD message to be transported over circuit services network 110 to the AT 102.

In one embodiment of the present invention, IWS 126 may be collocated at BS 112, and further may be located in either BTS 114 or BSC 116, and may be connected to packet data node 134 via an inter-RAN interface, that is, an interface terminating at BS 112 in circuit services network 110 and at packet data node 134 in the packet data network 130, preferably an A21 interface. In another embodiment of the present invention, IWS 126 may collocated at packet data node 134, and further may be located in either the AN or the PCF when the packet data node comprises an AN and/or a PCF, and may be connected to MSC 120 via an A1/A1p interface, and via the MSC to BS 112. When IWS 126 is collocated at packet data node 134, the A21 interface is internal to the packet data node. In yet another embodiment of the present invention, IWS 126 may be a standalone IWS that may be accessed by packet data node 134, for example, via an A21 interface, and by MSC 120, for example, via an A1/A1p interface. The A21 interface is used to transparently pass 1X air interface signaling messages between packet data node 134, and in particular a PCF or an AN of the packet data node 134 when the packet data node 134 includes a PCF and/or an AN, and IWS 126 or, when the IWS is collocated at BS 112, between packet data node 134 and the BS 112. In communication system 100 and unlike in the prior art, the A21 interface is further used to pass HRPD air interface signaling from packet data node 134, and in particular a PCF or an AN of the packet data node 134 when the packet data node 134 includes a PCF and/or an AN, to circuit services network 110.

Each of circuit services network 110 and packet data network 130 communicates with an IP Multimedia Core Network Subsystem (IMS) of home network 150. The IMS comprises an Interrogating Call Session Control Function (I-CSCF) and a Serving Call Session Control Function (S-CSCF), hereinafter collectively referred to as I/S-CSCF 154, that are each coupled to a Home Subscriber Server (HSS) 152 via a signaling (Cx) interface. The IMS of home network 150 further comprises a Voice Call Continuity Application Server (VCC AS) 156, that is coupled to HSS 152 via a signaling (Sh) interface and to I/S-CSCF 154 via a signaling interface capable of supporting Session Initiation Protocol (SIP). Similarly, Although FIG. 1 depicts I-CSCF and S-CSCF as being implemented in a single network element, such as a single server, those who are of ordinary skill in the art realize that I-CSCF and S-CSCF may be implemented in separate network elements without departing from the spirit and scope of the present invention. VCC AS 156, and MSC 120 as well, are each further coupled to a Home Location Register (HLR) 162 via a signaling interface that supports an inter-system protocol, such as Mobile Application Part (MAP). Although single interfaces have been described herein between many of the network elements of communication system 100, each interconnection among elements may comprise multiple interconnections and/or interfaces, such as one or more of a signaling interface, for example, an interface for an exchange of SIP, ISUP, MAP, or Megaco messages, and a bearer interface or path, such as a path for an exchange of voice information.

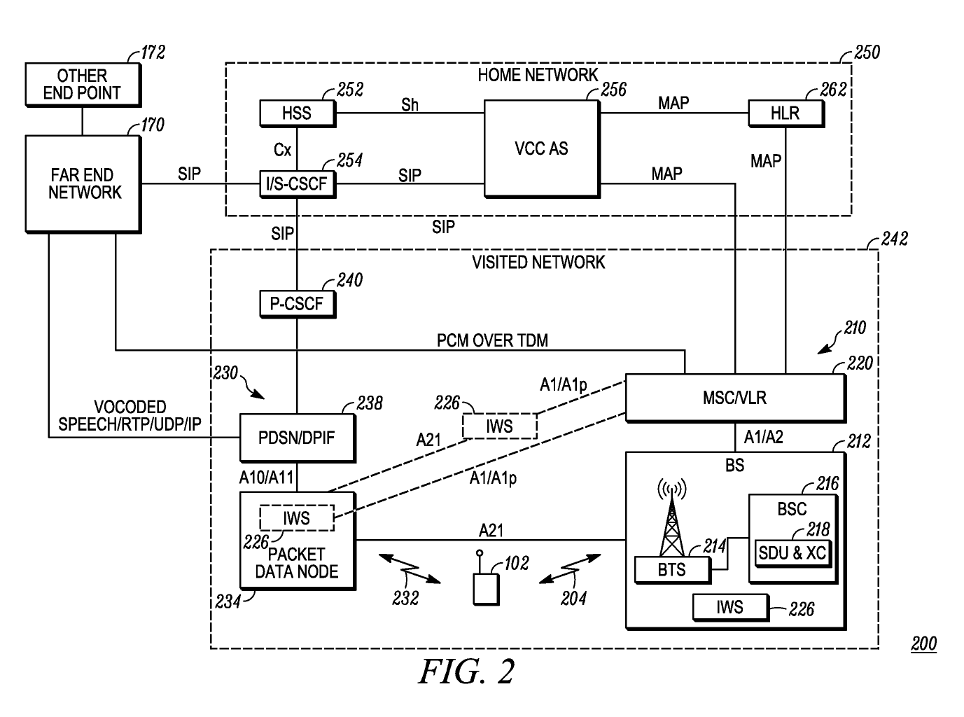

Referring to FIG. 2, a block diagram illustrates a wireless communication system 200, in accordance with some embodiments of the present invention. The wireless communication system 200 corresponds to the wireless communication system 100 with, however, the following changes. Components corresponding to the MGCF 124 and the MGW 122 in the visited network 142, as shown in FIG. 1, are not present in the visited network 242 as shown in FIG. 2. Further, a VCC AS 256 in the wireless communication system 200 has a MAP interface that connects to a MSC 220. The following elements in the wireless communication system 100 therefore correspond to the following elements in the wireless communication system 200: 104 to 204, 110 to 210, 112 to 212, 114 to 214, 116 to 216, 118 to 218, 120 to 220, 126 to 226, 130 to 230, 132 to 232, 134 to 234, 138 to 238, 140 to 240, 142 to 242, 150 to 250, 152 to 252, 154 to 254, 156 to 256, and 162 to 262.

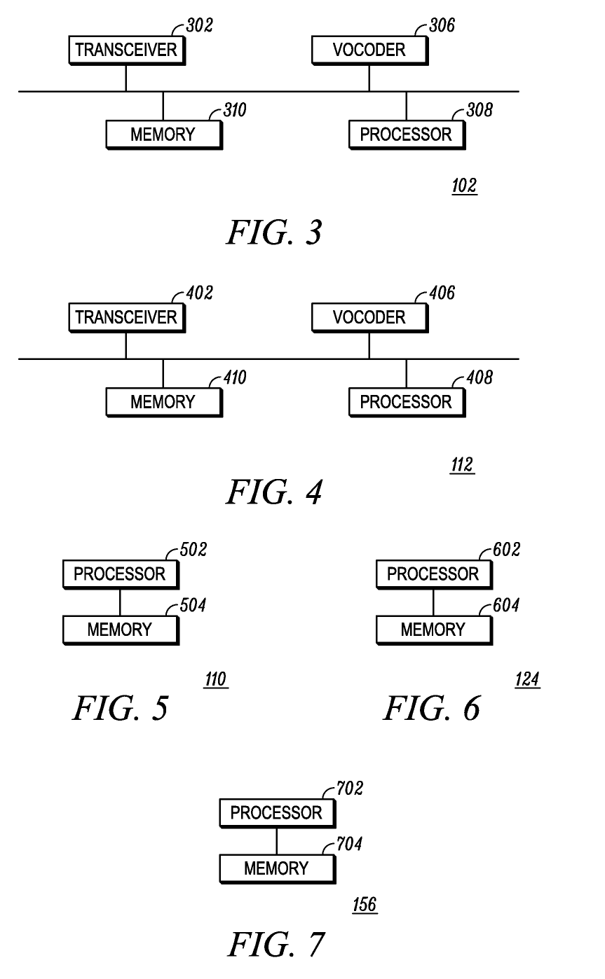

In FIGS. 3-7 below, examples of architecture concerning the AT 102, the BS 112, the MSC 110, the MGCF 124, and the VCC AS 156, respectively, are provided. For clarity and brevity, in the following description regarding FIGS. 3-7, references are made primarily to elements of only the wireless communication system 100. However, as will be understood by those skilled in the art, the description below also applies generally to the corresponding elements of the wireless communication system 200.

Referring to FIG. 3, a block diagram illustrates an architecture of the AT 102, in accordance with some embodiments of the present invention. AT 102 may include at least one transceiver 302 that allows the AT 102 to transmit or receive in each of the two networks 110 and 130. Transceiver 302 is coupled to a vocoder 306 and a processor 308, which processor 308 is further coupled to an at least one memory device 310. AT 102 may maintain apriori information in at least one memory device 310 that facilitates the switching between networks 110 and 130. Processor 308 may comprise one or more microprocessors, microcontrollers, digital signal processors (DSPs), combinations thereof or such other devices known to those having ordinary skill in the art, which are configured to execute the functions described herein as being executed by AT 102. The at least one memory device 310 may comprise random access memory (RAM), dynamic random access memory (DRAM), and/or read only memory (ROM) or equivalents thereof, that store data and programs that may be executed by the associated processor and that allow AT 102 to perform all functions necessary to operate in communication system 100. When AT 102 has a dormant packet data session being maintained by packet data network 130, the at least one memory device 310 may further maintain Radio Link Protocol (RLP) information associated with the packet data session, such as an identification of an HRPD RLP flow to which packet data is to be sent, for example, an ‘HRPD RLPFlowID.’

Referring to FIG. 4, a block diagram illustrates an architecture of the BS 112, in accordance with some embodiments of the present invention. BS 112 includes a respective processor 408, such as one or more microprocessors, microcontrollers, digital signal processors (DSPs), combinations thereof or such other devices known to those having ordinary skill in the art, which processor 408 is configured to execute the functions described herein as respectively being executed by the BS 112. BS 112 may include at least one transceiver 402 that allows the BS 112 to transmit or receive signals from the AT 102. Transceiver 402 is coupled to a vocoder 406, to the processor 408, and to an at least one memory device 410. The at least one memory device 410 may comprise random access memory (RAM), dynamic random access memory (DRAM), and/or read only memory (ROM) or equivalents thereof, that store data and programs that may be executed by the associated processor 408 and that allow the BS 112 to perform all functions necessary to operate in the communication system 100.

Referring to FIG. 5, a block diagram illustrates an architecture of the MSC 110, in accordance with some embodiments of the present invention. The MSC 110 includes a respective processor 502, such as one or more microprocessors, microcontrollers, digital signal processors (DSPs), combinations thereof or such other devices known to those having ordinary skill in the art, which processor 502 is configured to execute the functions described herein as respectively being executed by the MSC 110. The MSC 110 further includes a respective at least one memory device 504 that may comprise random access memory (RAM), dynamic random access memory (DRAM), and/or read only memory (ROM) or equivalents thereof, that store data and programs that may be executed by the associated processor 502 and that allow the MSC 110 to perform all functions necessary to operate in the communication system 100.

Referring to FIG. 6, a block diagram illustrates an architecture of the MGCF 124, in accordance with some embodiments of the present invention. The MGCF 124 includes a respective processor 602, such as one or more microprocessors, microcontrollers, digital signal processors (DSPs), combinations thereof or such other devices known to those having ordinary skill in the art, which processor 602 is configured to execute the functions described herein as respectively being executed by the MGCF 124. The MGCF 124 further includes a respective at least one memory device 604 that may comprise random access memory (RAM), dynamic random access memory (DRAM), and/or read only memory (ROM) or equivalents thereof, that store data and programs that may be executed by the associated processor 602 and that allow the MGCF 124 to perform all functions necessary to operate in the communication system 100.

Referring now to FIG. 7, a block diagram illustrates an architecture of the VCC AS 156, in accordance with some embodiments of the present invention. The VCC AS 156 includes a respective processor 702, such as one or more microprocessors, microcontrollers, digital signal processors (DSPs), combinations thereof or such other devices known to those having ordinary skill in the art, which processor 702 is configured to execute the functions described herein as respectively being executed by the VCC AS 156. The VCC AS 156 further includes a respective at least one memory device 704 that may comprise random access memory (RAM), dynamic random access memory (DRAM), and/or read only memory (ROM) or equivalents thereof, that store data and programs that may be executed by the associated processor 702 and that allow the VCC AS 156 to perform all functions necessary to operate in the communication system 100.

The functionality described herein as being performed by AT 102, BS 112, MSC 110, MGCF 124 and VCC AS 156 is implemented with or in software programs and instructions stored in the respective at least one memory device 310, 410, 504, 604 and 704 and executed by the associated processor 308, 408, 502, 602 and 702 of the AT 102, BS 112, MSC 110, MGCF 124 and VCC AS 156. When BS 112 comprises BTS 114 and a BSC 116, the functions described herein as being performed by the BS 112 may be performed by a processor included in BTS 114 or a processor included in BSC 116 or may be distributed among the processors of BTS 114 and BSC 116 based on data and programs respectively stored in a corresponding at least one memory device of BTS 114 and BSC 116. However, one of ordinary skill in the art realizes that the embodiments of the present invention alternatively may be implemented in hardware, for example, integrated circuits (ICs), application specific integrated circuits (ASICs), and the like, such as ASICs implemented in one or more of AT 104, BS 112, and packet data node 134. Based on the present disclosure, one skilled in the art will be readily capable of producing and implementing such software and/or hardware without undo experimentation.

In order for AT 102 to engage in a circuit voice call or a packet data call respectively via circuit services network 110 or packet data network 130, each of AT 102, circuit services network 110, and packet data network 130 operates in accordance with well-known wireless telecommunications protocols. For example, circuit services network 110 can be a cdma2000 (code division multiple access) communication system that provides circuit switched communication services to subscribers serviced by the network (it may also provide packet data services) and that operates in accordance with the 3GPP2 C.S0001 to C.S0005 standards, which provides an air interface compatibility standard for CDMA 1X systems. Packet data network 130 can be a cdma2000 communication system that provides HRPD communication services to subscribers serviced by the network 130 and that operates in accordance with the 3GPP2 (Third Generation Partnership Project 2) C.S0024-A standard, which provides an air interface compatibility standard for cdma2000 HRPD (High Rate Packet Data) systems and the 3GPP2 C.S0075 standard, which provides HRPD-1X inter-technology air interface support. The IP Multimedia Core Network Subsystem (IMS) of home network 150 operates in accordance with the 3GPP2 X.S0013 standards, which describe the operation, elements, and interfaces of an IMS.

Further, circuit services network 110 and AT 102 can operate in accordance with the 3GPP2 A.S0011-A.S0017 Inter Operability Specifications (IOS) standards, which provide a compatibility standard for cellular mobile telecommunications systems that operate as a cdma2000 1X system. In addition, packet data network 130 and again AT 102 can operate in accordance with one or more of the 3GPP2 A.S0008-B v0.2 or A.S0009-B v0.2 (v&v versions) HRPD IOS standards, which provide compatibility standards for cellular mobile telecommunications systems that operate as a cdma2000 HRPD system. To ensure compatibility, radio system parameters and call processing procedures are specified by the standards, including call processing steps that are executed by an AT and a base station or other access network serving the AT and between the base station or other access network and associated infrastructure. However, those of ordinary skill in the art realize that packet data network 130 may operate in accordance with any one of a variety of wireless packet data communication systems that provide high rate packet data communication services, such as systems conforming to the IEEE (Institute of Electrical and Electronics Engineers) 802.xx standards, for example, the 802.11, 802.15, or 802.16 or 802.20 standards, and that circuit services network 110 may operate in accordance with any one of a variety of well-known conventional wireless telecommunication systems that provide circuit switched communication services.

In order to access circuit services network 110, AT 102 tunes to an operating frequency assigned to the circuit services network 110, acquires a pilot channel associated with a serving BS, such as BS 112, and then registers with MSC 120 via BS 112 and a reverse link access channel of air interface 104. Once AT 102 is registered, the AT may monitor a forward link paging channel of air interface 104. The paging channel may then be used to notify AT 102 when a voice call arrives via circuit services network 110. Alternatively, AT 102 may originate a circuit voice call after acquiring the pilot channel associated with BS 112 by requesting circuit voice service on a 3G1X reverse link access channel. The paging channel is further used when packet data network 130 has received packet data from home network 150 and requests circuit services network 110 to page AT 102 to request the AT 102 to move to the packet data network 130 so that the packet data can be delivered to the AT 102.

When AT 102 is not engaged in a voice call with, or monitoring a paging channel in, circuit services network 110, the AT 102 may initiate a packet data call and register with packet data network 130, and more particularly with home network 150. AT 102 may then establish a data link with PDSN 138 in accordance with a Layer 2 protocol such as a Point-to-Point Protocol (PPP). The Point-to-Point Protocol may then be used to assign an IP address to AT 102. Once the IP address is assigned and a packet data session is established, AT 102 may communicate with packet data network 130 over a packet data network connection. The packet data network connection, comprising packet data node 134 and an AN and a PCF servicing AT 102 in network 130, is communicated by the packet data network 130 to MSC 120 and is stored by the MSC 120.

The C. S0024 standard provides for the packet data network packet data session to remain intact whether or not the connection is being used to support communications. That is, when AT 102 accesses packet data network 130 to establish a packet data session, the AT 102 is assigned a traffic channel in air interface 132 and packet data are transferred to the AT 102 via the traffic channel and the packet data network connection. During subsequent periods of inactivity in packet data network 130, for example, when AT 102 is active in a voice call in circuit services network 110, the traffic channel may be torn down but the packet data session remains intact. By maintaining the packet data session, AT 102 does not have to acquire a new IP address or establish a new PPP connection for a subsequent exchange of data. A packet data session that exists in the absence of a traffic channel is referred to as a “dormant” session.

In communication system 100, when AT 102 is engaged in a circuit voice call in circuit services network 110, the AT 102 may roam through the communication system 100. As a result of the roaming, situations may arise where it is desirable to hand off AT 102 from circuit services network 110 to packet data network 130. For example, as is known in the art, while roaming in communication system 100 and being serviced by BS 112, AT 102 may receive a stronger signal from packet data node 134. Typically signal strengths are determined by an AT, such as AT 102, measuring a pilot channel associated with the packet data node or BS. When a pilot channel of a serving packet data node or BS is weaker than a threshold value and a pilot channel of another packet data node or BS, that typically indicates a desirability of a handoff.

By way of yet another example, it may be desirable to move an AT, such as AT 102, that is actively engaged in a voice call in circuit services network 110 to packet data network 130 when the user of AT 102 prefers to use video telephony (VT) service rather than a voice call, and packet data network 130 supports video telephony but circuit services network 110 does not.

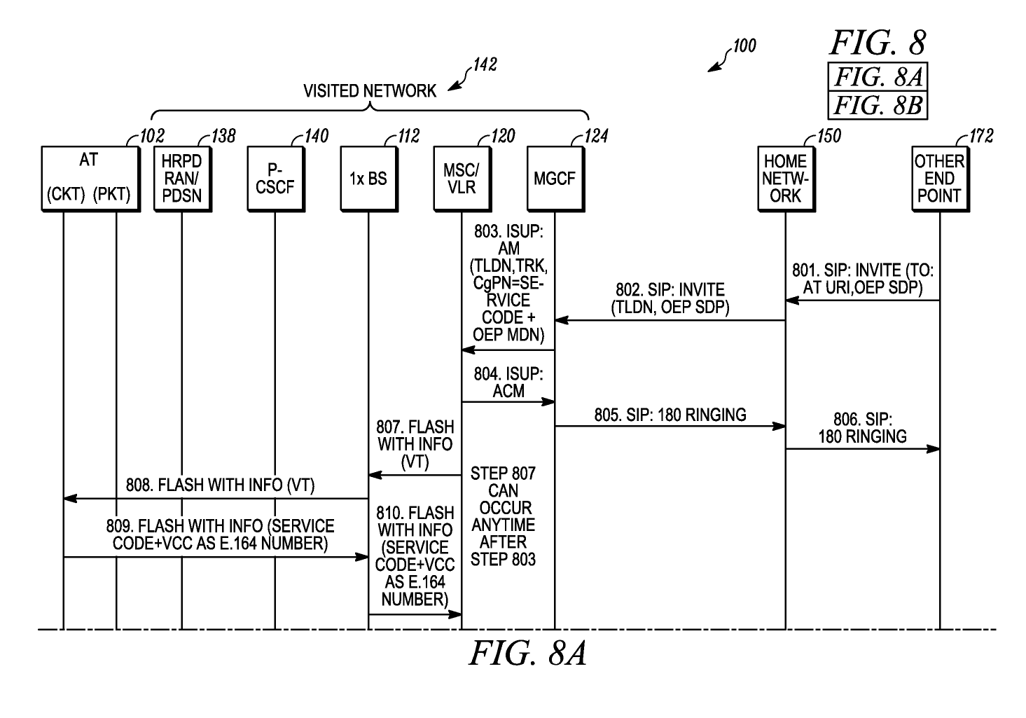

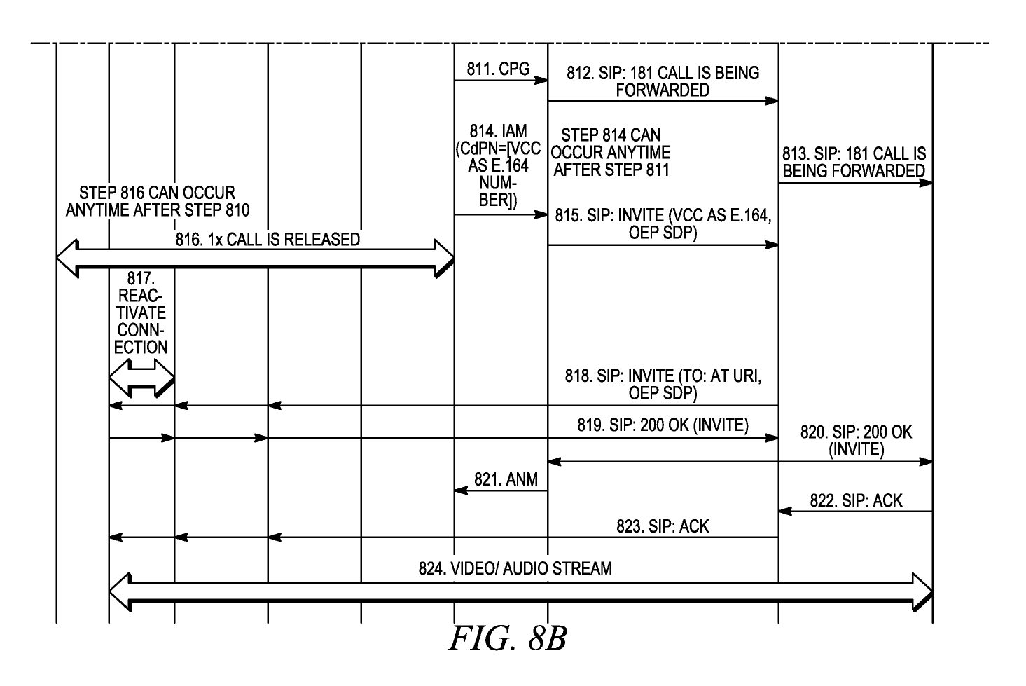

Referring to FIGS. 8A and 8B, a message sequence charts illustrate a method for establishing a video telephony (VT) call at the AT 102 that is processing an established circuit switched (CS) call through the circuit services network 110 of the communication system 100, according to some embodiments of the present invention. As described below, establishing the VT call includes notifying a user of the AT 102 of a request for the VT call. For purposes of FIGS. 8A and 8B, consider that the AT 102 is registered in an internet protocol (IP) multimedia subsystem (IMS) of the visited network 142 and includes an activated call waiting feature. Further, consider that the IMS of the visited network 142 does support user selective call forwarding and call deflection.

At step 801, the OEP 172 transmits a session initiation protocol (SIP) INVITE message, including a uniform resource identifier (URI) of the AT 102, and session description protocol (SDP) information concerning a requested VT call from the OEP 172, to the home network 150, requesting that a VT call be established between the OEP 172 and the AT 102. For example, the OEP 172 may be another cellular telephone or other type of communication device. At step 802, the home network 150 then transmits an SIP INVITE message to the MGCF 124 in the visited network 142. For example, the SIP INVITE message can include a temporary location directory number (TLDN) and SDP information that identifies the OEP 172. The TLDN can be retrieved from a HLR in the home network.

At step 803, the MGCF 124 then transmits an integrated systems digital network (ISDN) user part (ISUP) initial address message (IAM) to the MSC 120 in the visited network 142. The ISUP IAM requests that the MGW 122 be configured with an ephemeral termination connected to the OEP 172. The connection can be made for example with a physical pulse code modulation (PCM) trunk termination connected to the MSC 120. The ISUP IAM includes a calling party number (CgPN) comprising: a) a service code that indicates that this is a VT call and, if the user accepts it, the VT call is requested to be setup in the HRPD radio access network (RAN) in the visited network 142, and b) a mobile directory number (MDN) of the OEP 172. For example, in the ISUP IAM a calling party number has a prefix before a number of the OEP 172, where the prefix indicates that the new call is a VT call that needs to be setup in an HRPD system.

At step 804 the MSC 120 transmits an ISUP address complete message (ACM) back to the MGCF 124. At step 805 the MGCF 124 then transmits an SIP 180 Ringing message to the home network 150, and at step 806 the SIP 180 Ringing message is relayed to the OEP 172. At step 807, which can occur anytime after step 803, the MSC 120 transmits a flash with information (FWI) message to the BS 112. The FWI message comprises a call type indication that indicates that a new VT call is waiting. For example, the calling party number field in the FWI message contains a prefix that includes a service code that indicates that the new call is a HRPD VT call. Alternatively, an extended record type (ERT) can be used to indicate that the new call is a HRPD VT call.

At step 808, the BS 112 transmits a FWI message to the AT 102 that indicates that a new VT call is waiting. As at step 807, the calling party number field in the FWI message of step 808 contains a prefix that includes a service code that indicates that the new call is a HRPD VT call, or, alternatively, an extended record type (ERT) can be used to indicate that the new call is a HRPD VT call. Following step 808, a user of the AT 102 can determine whether or not to accept the VT call from the OEP 172. As will be understood by those skilled in the art, conventional call waiting features, such as audible tones, messages, or visual displays, can be used to inform a user of the AT 102 of the VT call. If it is determined to accept the VT call, then at step 809 the AT 102 transmits a FWI message to the BS 112 to indicate that the VT call from the OEP 172 should be forwarded to the AT 102. The FWI message at step 809 can include, for example, a keypad facility information record that includes: a) a pre-programmed feature code field that indicates user selective call forwarding to a number stored in the AT 102 as the first digits in the field, and b) a forwarding to number that is set to a VCC application server (AS) E.164 number, which can immediately follow the pre-programmed feature code field. At step 810, the FWI message is relayed from the BS 112 to the MSC 120.

At step 811, the MSC 120 then transmits to the MGCF 124 an ISUP call progress (CPG) message. At step 812, the MGCF 124 transmits an SIP 181 call is being forwarded message to the home network 150, and the SIP 181 message is then relayed at step 813 to the OEP 172. At step 814, which can occur anytime after step 811, the MSC 120 transmits to the MGCF 124 an IAM by using the VCC AS E.164 number in a called party number field. At step 815, the MGCF 124 determines the VCC AS SIP URI via, for example, an ENUM query and sends an SIP INVITE message to the home network 150.

At step 816, which can occur anytime after step 810, the 1X established circuit switched call is released by the AT 102. At step 817, the AT 102 is tuned to the packet data network 130 and a packet data session is reactivated with the PDSN 138. At step 818, the VCC AS 156 in the home network 150 determines that the call needs to be delivered to the IMS, and sends an SIP INVITE message to a proxy call session control function (P-CSCF) 170, to the PDSN 138, and to the AT 102. The SIP INVITE message includes a URI of the AT 102 and SDP information from the OEP 172. At step 819, an SIP 200 OK (INVITE) message is transmitted from the AT 102 to the PDSN 138, to the P-CSCF 140, and to the home network 150. At step 820, the SIP 200 OK (INVITE) message is then relayed from the home network 150 to the MGCF 124 and to the OEP 172. At step 821 the MGCF 124 transmits to the MSC 120 an answer message (ANM). At step 822, the OEP 172 transmits an SIP acknowledgement (ACK) message back to the home network 150, and at step 823 the home network 150 relays the SIP ACK message to the P-CSCF 140, to the PDSN 138, and to the AT 102. Finally, at step 824, the VT call is established between the AT 102 and the OEP 172, and video/audio data streams are transferred. As will be understood by those skilled in the art, other methods can be used to optimize the routing path. For purposes of clarity, the present description does not consider optimal routing paths.

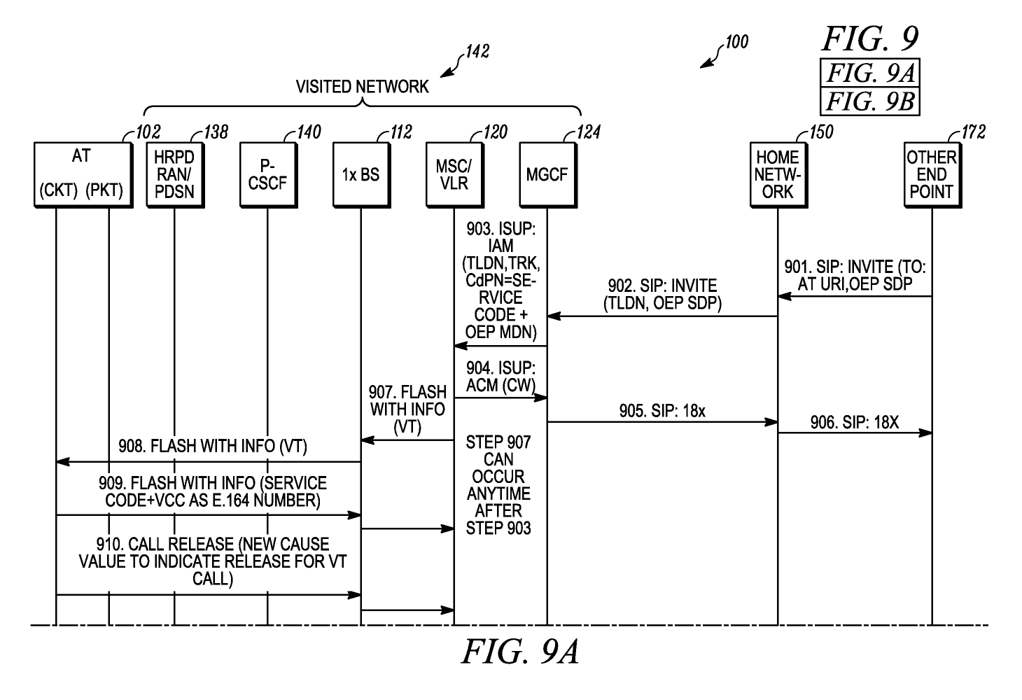

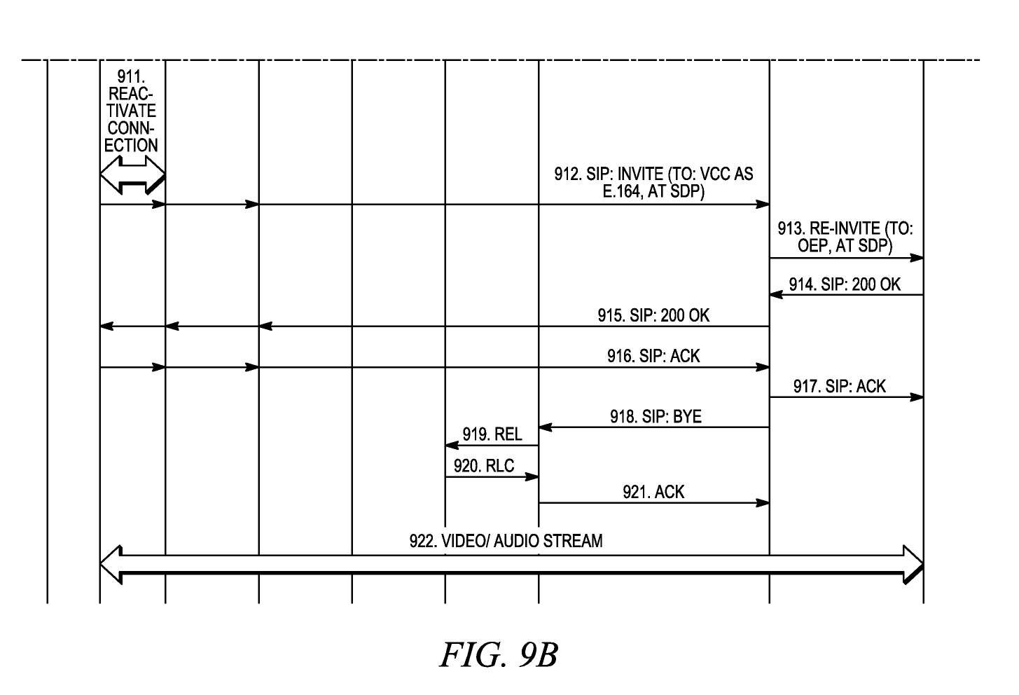

Referring to FIGS. 9A and 9B, message sequence charts illustrate a method for establishing a video telephony (VT) call through the circuit services network 110 of the communication system 100, according to some other embodiments of the present invention. As described below, establishing the VT call includes notifying a user of the AT 102 of a request for the VT call. For purposes of FIGS. 9A and 9B, consider that the AT 102 is registered in an internet protocol (IP) multimedia subsystem (IMS) of the visited network 142 and includes an activated call waiting feature. However, unlike in the message sequence chart described above with reference to FIG. 8, in FIG. 9 consider that the IMS of the visited network 142 does not support user selective call forwarding and call deflection. At step 901, the OEP 172 transmits a session initiation protocol (SIP) INVITE message, including a uniform resource identifier (URI) of the AT 102 and session description protocol (SDP) information concerning a requested VT call from the OPE 172, to the home network 150, requesting that a VT call be established between the OEP 172 and the AT 102. At step 902, the home network 150 then transmits an SIP INVITE message to the MGCF 124 in the visited network 142. For example, the SIP INVITE message can include a temporary location directory number (TLDN) and SDP information that identifies the OEP 172.

At step 903, the MGCF 124 then transmits an integrated systems digital network (ISDN) user part (ISUP) initial address message (IAM) to the MSC 120 in the visited network 142. The ISUP IAM requests that the MGW 122 be configured with an ephemeral termination connected to the OEP 172. The connection can be made for example with a physical pulse code modulation (PCM) trunk termination connected to the MSC 120. The ISUP IAM includes a calling party number (CgPN) comprising: a) a service code that indicates that this is a VT call and, if the user accepts it, the VT call is requested to be setup in the HRPD radio access network (RAN) in the visited network 142, and b) a mobile directory number (MDN) of the OEP 172. For example, in the ISUP IAM a calling party number has a prefix before a number of the OEP 172, where the prefix indicates that the new call is a VT call that needs to be setup in an HRPD system.

At step 904 the MSC 120 transmits an ISUP address complete message (ACM) call waiting (CW) back to the MGCF 124. At step 905 the MGCF 124 then transmits an SIP alerting (18x) message to the home network 150, and at step 906 the SIP 18x message is relayed to the OEP 172. At step 907, which can occur anytime after step 903, the MSC 120 transmits a flash with information (FWI) message to the BS 112. The FWI message comprises a call type indication that indicates that a new VT call is waiting. For example, a calling party number field in the FWI message contains a prefix that includes a service code that indicates that the new call is a HRPD VT call. Alternatively, an extended record type (ERT) can be used to indicate that the new call is a HRPD VT call.

At step 908, the BS 112 transmits a flash with information message to the AT 102 that indicates that a new VT call is waiting. As at step 907, a calling party number field in the FWI message of step 908 contains a prefix that includes a service code that indicates that the new call is a HRPD VT call, or, alternatively, an extended record type (ERT) can be used to indicate that the new call is a HRPD VT call. Following step 908, a user of the AT 102 can determine whether or not to accept the VT call from the OEP 172. As will be understood by those skilled in the art, conventional call waiting features, such as audible tones, messages, or visual displays, can be used to inform a user of the AT 102 of the VT call. If it is determined to accept the VT call, then at step 909 the AT 102 transmits a FWI message to the BS 112 to indicate that the VT call from the OEP 172 should be forwarded to the IMS, and the BS 112 forwards the FWI message to the MSC 120. However, if it is determined to reject the VT call, then the AT 102 continues the 1X established circuit switched call and does not reply to the FWI message received at step 908. Considering that the VT call is accepted, at step 910 a call release message is transmitted from the AT 102 to the BS 112, and is relayed by the BS 112 to the MSC 120. The call release message indicates that the 1X established circuit switched call should be released due to the acceptance of the HRPD VT call.

According to some embodiments of the present invention, a release cause value is defined in a 1X air interface and clear command interoperability specification (IOS) to indicate that the 1X established circuit switched call is released due to a switch to an HRPD VT call. When the MSC 120 processes the release cause value, which can be included in the call release message at step 910, the MSC 120 recognizes that an answer message (ANM) is not required to be sent to the MGCF 124.

At step 911, the AT 102 is tuned to the HRPD system and a packet data session is reactivated with the PDSN 138. At step 912, an SIP INVITE message is transmitted from the AT 102 to the PDSN 138, to the P-CSCF 140 and to the home network 150. The SIP INVITE message is addressed to the VCC AS 156 of the home network 150 and includes the AT 102's SDP information. The combination of the known E.164 number and a P-Asserted-Identity value identify the SIP INVITE message and indicate that a handoff to the VT call has been initiated. At step 913, the home network 150 transmits to the OEP 172 an SIP re-INVITE message that is addressed to the OEP 172 and includes SDP information identifying the AT 102. At step 914, the OEP 172 replies to the home network 150 by transmitting an SIP connect 200 OK message, which is then forwarded at step 915 by the home network 150 to the P-CSCF 140, to the PDSN 138 and to the AT 102. At step 916, the AT 102 then replies with an SIP ACK message that is transmitted to the PDSN 138, to the P-CSCF 140 and to the home network 150. At step 917, the home network 150 forwards the SIP ACK message to the OEP 172. At step 918, the home network 150 transmits an SIP release (BYE) message to the MGCF 124. At step 919, the MGCF 124 then transmits a release (REL) message to the MSC 120, and at step 920 the MSC 120 responds to the MGCF 124 with a release complete (RLC) message. At step 921, the MGCF 124 transmits an ACK message to the home network 150. Finally, at step 922, the VT call is established between the AT 102 and the OEP 172 and video/audio data streams are transferred.

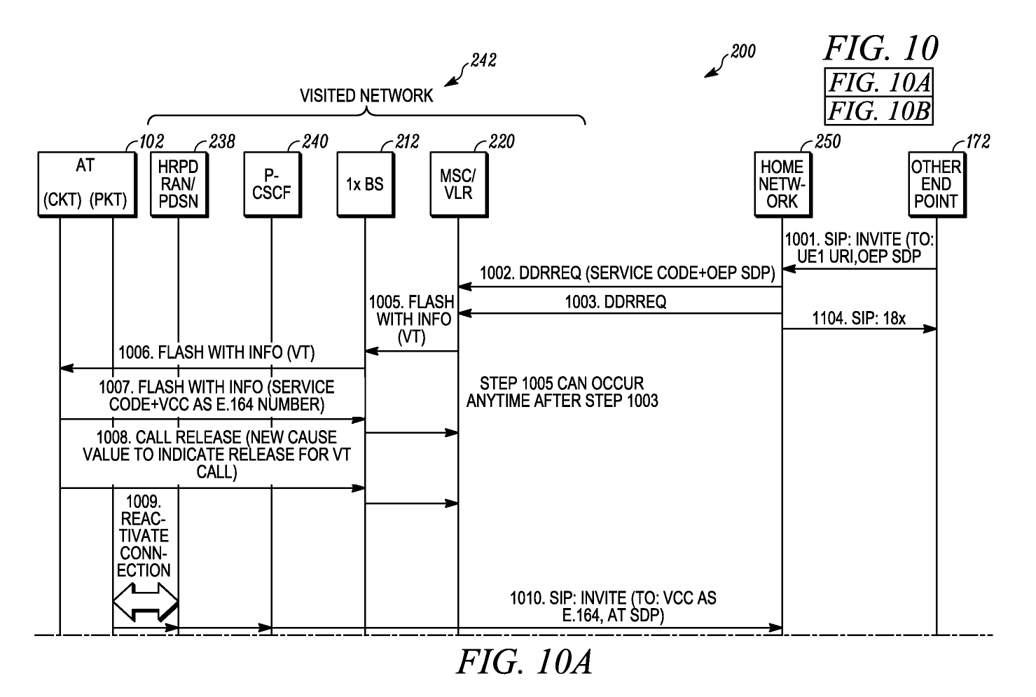

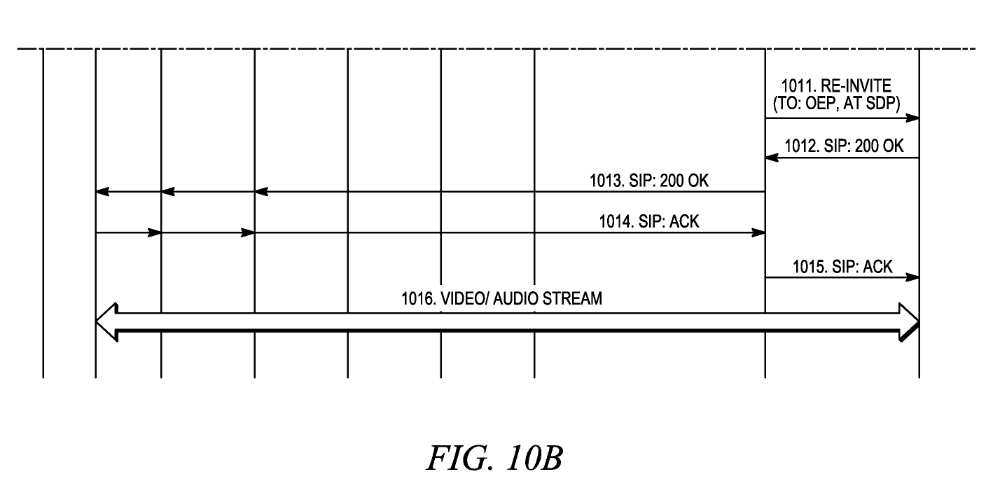

Referring to FIGS. 10A and 10B, message sequence charts illustrate a method for establishing a video telephony (VT) call through the circuit services network 210 of the communication system 200, according to some other embodiments of the present invention. As described below, establishing the VT call includes notifying a user of the AT 102 of a request for the VT call. For purposes of FIGS. 10A and 10B, consider that the AT 102 is registered in an internet protocol (IP) multimedia subsystem (IMS) of the visited network 242 and includes an activated call waiting feature. As in FIG. 9, consider in FIG. 10 that the IMS of the visited network 242 does not support user selective call forwarding and call deflection. At step 1001, the OEP 172 transmits a session initiation protocol (SIP) INVITE message, including a uniform resource identifier (URI) of the AT 102 and session description protocol (SDP) information concerning a requested VT call from the OPE 172, to the home network 250, requesting that a VT call be established between the OEP 172 and the AT 102. At step 1002, because the AT 102 is in a 1X call, the home network 150 transmits a data delivery redirection request (DDRREQ) message to the MSC 220. The DDRREQ message contains a call type indication for the VT call. For example, the call type indication can comprise a prefix before the calling party number. At step 1003, the MSC 220 transmits a response to the DDRREQ message to the home network 250, and the home network 250 relays an SIP 18x message to the OEP 172.

Steps 1005 through 1015 then proceed in a manner similar to the corresponding steps 907 through 917 as shown in FIG. 9 concerning the communication system 100 and described in detail above. For brevity, the corresponding steps 1005 through 1015 concerning the communication system 200 are not described in detail as they will be understood by those skilled in the art in light of the description above.

Finally, at step 1016, the VT call is established between the AT 102 and the OEP 172 and video/audio data streams are transferred.

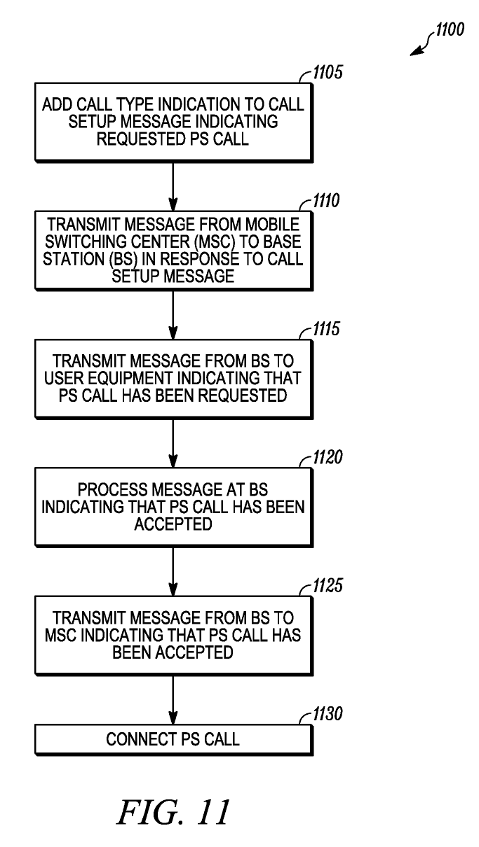

Referring to FIG. 11, a general flow diagram illustrates a method 1100 for establishing a packet switched (PS) call, such as a video telephony (VT) call, at an access terminal (AT) that is processing an established circuit switched (CS) call, according to some embodiments of the present invention. A packet switched call refers to any of various types of voice or data services provided through a packet data network. At step 1105, a call type indication is added to a call setup message, such as an initial address message or DDRREQ in a serving network, where the call type indication indicates that the PS call is requested to be setup in a high rate packet data (HRPD) radio access network (RAN) in the serving network. For example, at step 803 shown in FIG. 8, an ISUP IAM includes a calling party number (CgPN) comprising: a) a service code that indicates that a VT call is requested to be setup in the HRPD RAN in the visited network 142, and b) a mobile directory number (MDN) of the OEP 172. At step 1110, a message in response to the IAM is transmitted from a mobile switching center (MSC) in the serving network to a circuit switched (CS) base station (BS) in the serving network. For example, at step 807 shown in FIG. 8, a flash with information (FWI) message is transmitted to the BS 112. Next, at step 1115, a message indicating that the PS call has been requested is transmitted from the BS to the AT. For example, at step 808 shown in FIG. 8, a FWI message is transmitted to the AT 102. At step 1120, a message from the AT indicating that the PS call has been accepted is processed at the BS. For example, at step 809 shown in FIG. 8, a FWI message is transmitted to the BS 112. At step 1125, a message indicating that the PS call has been accepted is transmitted from the BS to the MSC. For example, at step 810 shown in FIG. 8, a FWI message is transmitted to the MSC 120. Finally, at step 1130, the PS call is connected. For example, step 811 through step 824 shown in FIG. 8 are completed.

Advantages of embodiments of the present invention thus include enabling an access terminal that has dual mode capabilities, such as a dual mode cellular telephone or other wireless communication device, that is operating in a circuit switched mode and processing an established circuit switched call, to receive a message indicating that a packet switched call, such as a video telephony call, to the access terminal has been requested. Using a call waiting feature of the access terminal, a user is able to either accept or reject the requested packet switched call. If the packet switched call is accepted, the circuit switched call is released and the packet switched call is established.

The above detailed description provides an exemplary embodiment only, and is not intended to limit the scope, applicability, or configuration of the present invention. Rather, the detailed description of the exemplary embodiment provides those skilled in the art with an enabling description for implementing the exemplary embodiment of the invention. It should be understood that various changes can be made in the function and arrangement of elements and steps without departing from the spirit and scope of the invention as set forth in the appended claims. It will be appreciated that embodiments of the invention described herein may be comprised of one or more conventional processors and unique stored program instructions that control the one or more processors to implement, in conjunction with certain non-processor circuits, some, most, or all of the functions of establishing a packet switched call at an access terminal that is processing an established circuit switched call as described herein. The non-processor circuits may include, but are not limited to, a radio receiver, a radio transmitter, signal drivers, clock circuits, power source circuits, and user input devices. As such, these functions may be interpreted as steps of a method for establishing a packet switched call at an access terminal that is processing an established circuit switched call. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A method for establishing a packet switched call at an access terminal that is processing an established circuit switched call, the method comprising:
adding a call type indication to a call setup message in a serving network, wherein the call type indication indicates that the packet switched call is requested to be setup in a packet data radio access network in the serving network;
transmitting from a mobile switching center in the serving network to a circuit switched base station in the serving network, in response to the call setup message, a message indicating that the packet switched call has been requested;
transmitting from the circuit switched base station to the access terminal a message indicating that the packet switched call has been requested;
processing at the circuit switched base station a message from the access terminal indicating that the packet switched call has been accepted;
transmitting from the circuit switched base station to the mobile switching center a message indicating that the packet switched call has been accepted; and
connecting the packet switched call.

2. The method of claim 1, further comprising transmitting the call setup message from a media gateway control function to the mobile switching center in the serving network.

3. The method of claim 1, wherein the messages received at the circuit switched base station and the message transmitted from the circuit switched base station are flash with information messages.

4. The method of claim 1, wherein the message transmitted from the mobile switching center to the circuit switched base station, and the message transmitted from the circuit switched base station to the access terminal, indicating that the packet switched call has been requested, comprise a calling party number field having a prefix service code, or an Extended Record Type, that indicates that the packet switched call has been requested.

5. The method of claim 1, wherein the call type indication comprises a service code that is a prefix to a calling party number.

6. The method of claim 1, wherein the message received at the circuit switched base station from the access terminal, indicating that the packet switched call has been accepted, comprises:
a pre-programmed feature code indicating user selective call forwarding; and
a forwarding to number.

7. The method of claim 6, wherein the forwarding to number is a voice call continuity application server E.164 number.

8. The method of claim 1, wherein the message transmitted from the circuit switched base station to the mobile switching center, indicating that the packet switched call has been accepted, comprises:
a pre-programmed feature code indicating user selective call forwarding; and
a forwarding to number.

9. The method of claim 8, wherein the forwarding to number is a voice call continuity application server E.164 number.

10. The method of claim 1, wherein connecting the packet switched call comprises transmitting, from a media gateway control function in the serving network, to a voice call continuity application server in a home network a session initiation protocol INVITE message that includes session description protocol information identifying another end point.

11. The method of claim 10, wherein the home network transmits, in response to the session initiation protocol INVITE message that includes session description protocol information identifying another end point, a session initiation protocol INVITE message to the access terminal.

12. The method of claim 1, wherein the message transmitted from the access terminal to the circuit switched base station, and the message transmitted from the circuit switched base station to the mobile switching center, indicating that the packet switched call has been accepted, are followed by a message comprising a release cause value that indicates that the circuit switched call is released due to establishment of the packet switched call.

13. The method of claim 1, wherein connecting the packet switched call comprises transmitting, from the access terminal to a voice call continuity application server in a home network, a session initiation protocol INVITE message that includes session description protocol information identifying the access terminal.

14. The method of claim 1, wherein the call setup message comprises an initial address message or a data delivery redirection request message.

15. The method of claim 1, wherein the method conforms to a Third Generation Partnership Project 2 standard.
